(19) United States
(12) Patent Application Publication
(10) Pub. No.: US 2013/0218802 A1
(43) Pub. Date: Aug. 22, 2013

(54) METHOD FOR RANKING COMPANIES PROVIDING GOODS AND SERVICES IN A MARKETPLACE, AND USES OF THE METHOD IN AN ONLINE SEARCHABLE DATABASE OF SUCH COMPANIES

(71) Applicant: Kevin Kliland, Oslo (NO)

(72) Inventor: Kevin Kliland, Oslo (NO)

(73) Assignee: YELLOWRATE AS, Oslo (NO)

(21) Appl. No.: 13/401,427

(22) Filed: Feb. 21, 2012

(51) Int. Cl. G06Q 30/00

(52) U.S. Cl. 705/347

(57) ABSTRACT

In a method for ranking companies providing goods and services in a marketplace, sources of information about the companies are identified and parametrisized according to the information given in the sources. For all parameters, scores are determined for each company and the aggregated scores of a company are applied for computing a rank value of the company.

Uses in online searchable databases or web services open to end users searching company information.

### A. INTRODUCTION

The present invention concerns a method for ranking companies providing goods and services in a marketplace. The invention also concerns uses of the method in an online searchable database of companies of this kind in a marketplace.

There are virtually no available open service for company rankings today that points to which companies are good, bad, expensive, cheap etc. For instance where does one go to find a good plumber and carpenter today? Usually one relies on often very subjective recommendations. Minor efforts are done in this matter by organization forums that certify their members. Several parameters can be monitored, e.g. quality of work, price and responsiveness. But it is not it easy to find and look up all relevant information on a particular company one wants to collect information about, as the information sources are scattered.

Presently an end user lacks four important dimensions when trying to identify good companies:
1. Access to an open company site revealing the top ranked companies in order to overcome poor service levels.
2. A central point of trust for all companies to overcome the problem of whom to trust when navigating in an immature service market space.
3. One interface. A central point of contact for all services to overcome the problem of where to find relevant services.
4. Tailor-made links to external company information sources based on the exact firm one searches for.

### B. OBJECTS OF THE INVENTION

In view of the above-mentioned shortcomings it is a primary object of the present invention to provide a method for ranking companies offering goods and services, and to enable an end user to select a company on the basis of an objective rank reflecting the quality of the goods and services or customer satisfaction and the public relations in a wider context. It is also an object of the present invention to provide a method of this kind that can be used in searchable databases of companies offering goods and services.

### C. REALIZATION OF THE OBJECTS

The above objects are realized by the subject matter as disclosed in the independent claims. Further features and advantages will be evident from the appended dependent claims.

The invention shall below be disclosed in more detail with reference to the appended figures of which

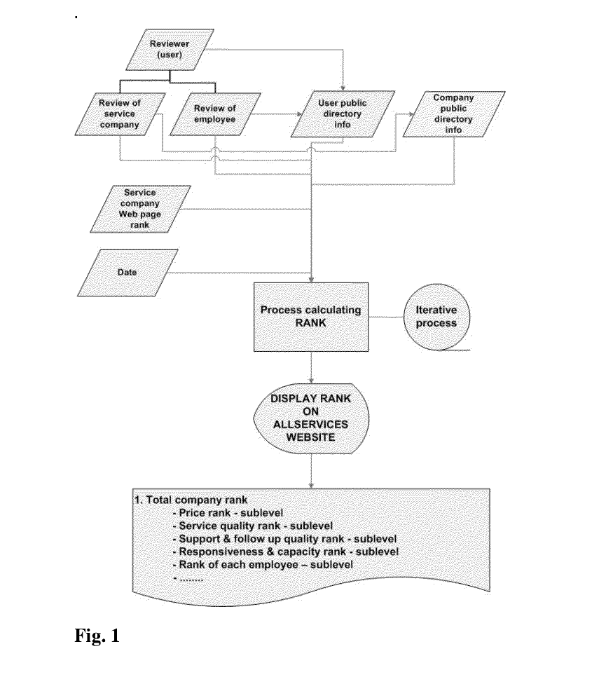

FIG. 1 shows a schematic view of the data model and process used to implement the ranking method of the invention, and

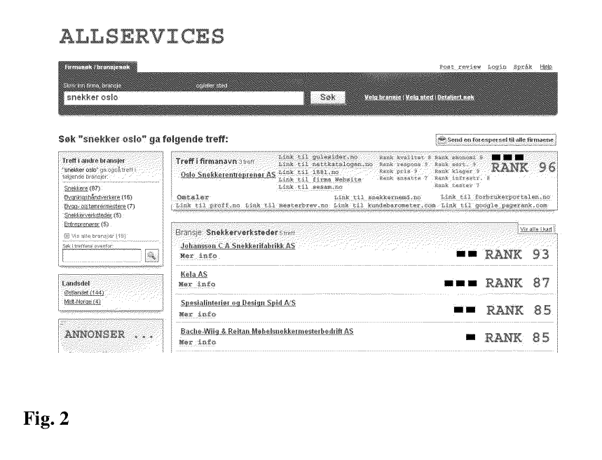

FIG. 2 shows the result of a search a presented to a user of the database service employed in the present invention.

### D. DETAILED DESCRIPTION

### 1. General

The method of the invention is implemented in an online searchable database, also called the Website or the Service Website in the following. Its interface towards customers will be World Wide Web. Therefore it is vital to establish a good and self-contained website. The website must support a number of languages and countries (nationalization) since the same site will be deployed worldwide. The same site must also handle segmentation into several cities or regions within each country since it is the companies in each city or region that will be ranked.

The Website will be easy to navigate for accessing any kind of service supplier. It will be possible to navigate by a comprehensive search module or simply by looking up the different service categories as per city/region or country. It will also be possible to get help to identify the service category and company where it is hard to identify the service category that can help with a particular issue.

To the extent possible, most companies will be pre-populated in the database through public directory information, in Norway through www.brrreg.no, which is the official (public) register of organizations and business enterprises. Also the links to the external catalogue sites and external ranking source sites will be pre-populated to the extent possible. This is explained further below in this section. It might also be possible to establish a panel comprising thousands of users, e.g. through a poll survey company, where the users are obliged to enter information on the site of all the service companies they use. This approach is, however, not contemplated for the present invention. A panel costs money to establish and operate. As an example Forbrukerrådet (the Norwegian national council for securing the consumers' rights and providing info and guidance/advices/reviews; www.forbrukerradet.no) has established a panel of 40.000 users.

### 2. User-Generated Content

The website will include a mechanism for collecting user feedback, i.e. the users will populate some of the data, other data will be retrieved from public directories as mentioned above.

By default the users will be asked to link to the websites storing catalogue and external ranking sources about the relevant company if not already pre-populated and present. The most relevant links will be placed on top. The users will in the manner of a standard “Wiki” decide what the most relevant links are. The links may be catalogue services as well as company websites. This feature is, however, neither a necessary nor a critical feature, but could be implemented in later versions of the Website.

There will be a separate section on the Service Website where the users can add neutral catalogue service company profile data for missing information.

Neither is this feature necessary or critical, but could likewise be implemented in later versions of the Website.

A distinct trend today is that many of the most visited and popular websites are based on user-generated content, e.g. Wikipedia, YouTube, Facebook, Twitter, TripAdvisor and more.

### 3. Ranking

It is a comprehensive job to identify and select good companies. When the times are good there is a risk that most trades, e.g. carpenters, deliver bad quality services due to high demand and that they get well paid regardless of the quality they deliver. Another problem may be that companies which offered good services when they are small, may run into problems maintaining the service level when they grow bigger. Other issues to be taken into account is e.g. that a company that delivers good quality services may respond slowly and at a high price. All these issues are however addressed by the dynamic processes disclosed herein, since these at any time will aim at giving a good and representative picture of each company.

It must be possible for the users to post their opinion on each company as per city or region. Experience from other similar systems supporting user-based reviews should be considered.

An incentive program may be looked into for making it attractive to post reviews.

The most recent reviews will be given the highest priority.

A post-processing system will be based on the user reviews and other parameters outlined further below in this section and automatically rank the various companies top-down within each category as per city, region and country by means of a ranking algorithm. The input to this algorithm will be weighted scores of each parameter.

FIG. 1 shows a schematic view of the data model and process used to generate a ranking score for a particular company or provider entered in a database of the Service Website. A set of parameters relevant for the measure of a provider's or company's quality with regard to goods and service offered and public reputation, business conduct and ethical behaviour is selected and each populated with a score based on input from a variety of sources as shown in FIG. 1. Dependent on available sources it is evident that some parameters cannot be populated for a particular provider. The score for a specific parameter is weighted and used in an algorithm for calculating the company rank as a weighted aggregate of scores. The overall rank or rank value can be entered in the database and displayed for a user as an overall indicator of the quality of the company or provider. The total company rank can be broken down into various sublevels, thus providing the user of the database a more fine-grained view of the company performance. Input data for the various sources will at present generally be manually extracted and entered in the ranking process. In addition ranking can also take into account links to the companies from documents posted on the WWW. This can be done automatically by crawling or using Google's PageRank. It is evident that such links can be associated with a specific parameter in the parameter set used for scoring. The preliminary score for each parameter is weighted and the weight should reflect the relevance of the parameter, i.e. the parameter used may have varying degree of relevance as a measure of quality of the company. It is thus obvious that documents on the web linking to the company can be displayed in an order determined by their parameter association and thus reflecting relevance. As mentioned, the data entry, at present from the various sources, some of which are listed in the following, generally will have to be done by manual methods; however, in some cases this process may be automated, for instance on the basis of frequency lists or number of occurrences in a particular source. If the source is for instance a particular board of complaints, the number of times a particular company has been the subject of a complaint can be extracted and frequency lists for the companies that have appeared in that particular board of complaints can be generated and used for establishing a preliminary score. In other words, the possibility of lessening the burden of manually inputting the data depends on how each particular source presents the relevant data.

A message will be displayed for the users posting reviews, telling them that reviews submitted on behalf of a company is not allowed, and that if such activity is identified, it might affect the ranking of the company. Users providing full name, address, phone number or similar will be ranked higher than the anonymous users.

Parameters which will be weighted and parts of the reviews used to identify the best service offerings are:
Price
Quality of the actual service. Education level and professionalism of the employees
Quality of support personnel and follow-up. This is applicable for complaints etc.
Capacity, i.e. response time to get the job done

All these parameters will be displayed when the user wants to see fine-grained ranking details of a company. In addition to normal user reviews, various other technologies will be used to enhance the ranking confidence. For the companies having a website, the page rank of the website will be taken into account. Also other public sites will be used to retrieve relevant data when applicable and legal, e.g. public catalogue information sites as the Norwegian public register for organizations and business enterprises and legal information and financial information thereof (www.brreg.no); the Norwegian national council for consumers' rights which also provides information and guidance/advices/reviews (www.forbrukerradet.no); the organizations certifying service companies; in Norway “Mesterbrev”; (www.mesterbrev.no), and more. In Norway certain organizations take care of handling complaints within each category of service, e.g. for real estate it is http://www.eiendomsmeglingsnemnda.no/index.gan?id=46&subid=0.

In total there are 24 of these organizations in Norway and each of them will be used as a source for ranking. The public sector in Norway has a database of prequalified service companies that will be approached as a source for ranking.

In Norway BI (an educational business school) offers a Kundebarometer; http://www.kundebarometer.com/, i.e. a combined survey and measurement of customer satisfaction performance of the most well-known companies. It has been operating since since 1995. It is a goal to use this source as an input to the ranking algorithm and preferably use the same criteria and ranking algorithms to make the datasets compatible. It is available as http://www.kundebarometer.com/index.php?content=nkbmodell, http://www.kundebarometer.com/index.php?content=nkbmodellmetode or as http://www.kundebarometer.com/index.php?content=nkbmodellmod.

The service will provide open ranking information, but the user will also get the possibility to log onto the Service Website to get an even more confident ranking. When logged in, the user can configure priority with respect to the criteria he considers most important, e.g. price vs. quality of service, responsiveness etc. to get a further enhanced ranking aligned with his settings (this will not be included in a first version but is not a critical feature). To the extent possible, the users' nearest acquaintances will be weighted the most, or being the only ones weighted if desired. A Facebook application will be made initially to provide support to the closed user group (logged-in) service. The data generated from the closed user groups will also be used for the public ranking. Facebook is a very important and probably the main approach for populating the content.

Interfaces to maps (e.g. Google Map) and location-based services to identify geographically close companies can be offered. The geographical position must then be known.

The service may offer Web based access to its service on all major platforms such as Windows, MAC; Linux, Symbian, Windows Mobile and browsers; IE 8.0/7.0, Firefox, Google Chrome, Opera, Opera Mini.

The ranking method as shown in FIG. 1 can be rendered in a pseudo-algorithmic form as given by the following example.

### EXAMPLE 1

### Ranking Pseudo-Algorithm

```
Precondition: All companies are present in the database.
Sources are e.g. certification, tests, complaints, financial numbers,
company user feedback, company structure etc. etc.
    1. X = 1 to NUMBER_OF_SOURCES_USED _FOR_RATING
    2. (Source_x(Weight_y)) ; Enter source and corresponding weight.
      Each source has a specific weight
    3. X = X + 1
    4. GOTO LINE 1
A Finding is an instance of a Source
    1. X = 1 to NUMBER_OF_FINDINGS_ON_COMPANIES ; Loops
      through all finding on all companies
    2. (Finding_x(Company_y, Score_z, Source_a)) ; Map Finding_x
      to a corresponding source, company and score
    3. MAX_WEIGHT_COMPANY_Y =
      MAX_WEIGHT_COMPANY_Y
      + Weight(Source(Finding_x)); All max weights will be stored for
      all companies
    4. X = X + 1
    5. GOTO LINE 1
    1. X= 1 to NUMBER_OF_FINDINGS_ON_COMPANIES ; Loops
      through all finding on all companies
    2. COMPANY_SCORE_Y = Company_y(Finding_x( )) ; Lookup
      last stored score result on this particular company with
      Finding_x as inparameter
    3. COMPANY_SCORE_Y = COMPANY_SCORE_Y +
      Weight(Source(Finding_x( ))) × Score(Finding_x( )) /
      MAX_WEIGHT_COMPANY_Y ; All score results for all
      companies are accumulated and updated and must for each cycle
      also be stored so that the result later can be looked up in step 2
      above
    4. X = X + 1
    5. GOTO LINE 1
Note:
Each function has inverse functions, e.g. Source(Weight) has an inverse function Weight(Source), i.e. the input is Source and the Weight for that particular Source is returned. This also applies in the same way to the function Finding(Company, Score, Source), as this function will have two inverse functions that from a particular instance of a Finding can return the corresponding Source as well as the Score.
```

### 4. The Ranking Website

This is just an example and one view on what the user may see when looking up ranking information on a particular company:
Service: Carpenter
   Country: Norway
      City: Oslo
         COMPANY RANKED #1
         Name: Old Pal Carpenter Company AS
         Links to external catalogue sites
         RANK Total (1-6): 5
         RANK price: 5
         RANK quality: 6
         RANK response-time: 5
         RANK finished on time: 3
         RANK economy: 5
         User reviews (click here)
         I want to post a review (click here)
         I want to update the catalogue information (click here)
         COMPANY RANKED #2
         . . .

In addition a confidence barometer will display how confident a certain ranking is based on ranking sources and number of user reviews.

A (theoretical) illustration of what the service may look like in a Norwegian version, but not necessarily the final result, is shown in FIG. 2. Here a search of the Service Website for carpenters, using the phrase “carpenter oslo” (“snekker oslo”) has generated 4 hits, shown in the boxes on right, with associated ranks. One hit (upper box) has been expanded to show more fine-grained rankings such as quality, complaints, price etc. The black markings for each hit indicates the confidence of the ranking based on the number of sources and reviews that has been used. The score scale used here is [1,100], but could be any scale of the form [1,n], using integers only.

When performing ranking some mapping between global feedback parameters received on a company from external sources as a whole and a local feedback on a subsidiary branch must be made.

Representative Norwegian directories used with the present invention are given in Example 2 below. The approach will be used as per country

### EXAMPLE 2

### The Exact Interfaces to Ranking Source Input Public Directory Same Information Targeting Norway

The National Public Register of companies at: www.brreg.no for financial and other relevant information. Also important for pre-populating the listings on the companies
Certifird craftsmen; www.mesterbrev.no
Comments from Yellow Pages (Gule sider); www.gulesider.no
Certified companies; www.be.no
“The Professional Advising Board for wet rooms”; www.ffv.no
Restaurant reviews;
http://oslopuls.aftenposten.no/liste/?type=review&listSection=restaurant_uteliv
Hotel reviews; www.hotels.com
BI's company customer satisfaction guide; http://www.kundebarometer.com/
Google PageRank
Reviews will count but how much depend on numbers
Tests of the National Council for Consumers' Rights; http://forbrukerportalen.no/tester (0-3)
The 24 Norwegian organizations handling consumers and complaints (0 to minus 6)

The last-mentioned 24 organizations are listed on the website www.forbrukerportalen.no: and disclosed in the Appendix appended to the description.

_A core feature of the service is to display tailor-made company search information. This means that the relevant links in the previous section will be displayed to the user searching for a particular company. In addition to the links outlined in the previous section, some or all of the following links will be displayed. They are all telephone directories and have counterparts in most industrialized countries.

### EXAMPLE 3

### Interfaces to Public Directory Information Targeting Norway

www.gulesider.no
www.1881.no
www.nettkatalogen.no
www.sesam.no
http://www.guruguiden.no/
www.purehelp.no
www.mittoppdrag.no
www.anbudstorget.no
www.godtjobba.no (from Maxbo)

All these links as well as the links in the previous section will lead to the exact company searched for when possible. The exact links that will be displayed depends on which category the company belongs to, and is carried out by an advanced search-filter mechanism

The same approach will be used as per country.

### E. Outlook

The method of the invention is used in an online searchable database service, which is based on the use of various technologies to make the community more or less self-contained and to be able to offer a very good service which requires very little administration and accordingly is cheap to operate and use. The service will be based on a combined user-generated and pre-provisioned model.

The ranking will partly be based on user reviews which also will cover feedback on the employees as a whole. A distinct trend today is that many of the most visited and popular websites are based on user-generated content, e.g. Wikipedia, YouTube, Facebook, Twitter, TripAdvisor and more. The advanced ranking method of the present invention retrieves data from service companies' Web pages where applicable, data from public official directory services, and more. The user reviews will be weighted less than data retrieved from the other sources.

The actual neutral catalogue information (e.g. name, address, contact information, organization number, map information, CEO) for each company will be offered through the Service Website, but external links from the ranking as used with the present invention to other relevant web and catalogue sites will also exist. If no good relevant site maintains this information, the users will later be offered the possibility to manually add the relevant catalogue information for a particular company on the Service Website. To the extent possible, the database service will have pre-populated the links to the relevant WWW and catalogue sites. It will also be possible for the users to establish links from the ranking Website to the WWW and catalogue sites when missing.

Help with the stages after identifying the company, e.g. generating of templates for contracts etc., will also be provided to offer a one-shop-stop.

A user logged onto the database service might be able to get a more confident ranking by weighting the reviews of acquaintances' more (or only those) than those from non-acquaintances. A Facebook application will be made to support the closed user group (logged-in) service. Through Facebook people can provide information to their friends about which companies they like and vice versa. Facebook is also an excellent marketing channel. The data generated from the closed user groups will also be used for the public ranking service and is a good approach to populating the content.

### APPENDIX

Norwegian Boards of Complaints, listed for various services
Banks
http://forbrukerportalen.no/Organisasjoner/bankklagenemnda
http://www.bankklagenemda.no/
Automobiles (not open site, can't be used)
http://forbrukerportalen.no/nemnd/bilklagenemnda
http://www.navigo.no/marked/bilforhandlerforening/klagenemnd.htm
Housing/Apartments
http://forbrukerportalen.no/Organisasjoner/boligtvistnemnda
General Consumers' Complaints Board
http://forbrukerportalen.no/nemnd/1138790105.75
https://www.brukerklagenemnda.no/
Lawyers
http://forbrukerportalen.no/Organisasjoner/klagenemnd_advokat (not open site, cannot be used)
http://forbrukerportalen.no/nemnd/1147699488.89 (“Disiplinaersystemet for advokater”)
Electricity
http://forbrukerportalen.no/Organisasjoner/elklagenemnda
http://www.elklage.no/
Air travel
http://forbrukerportalen.no/Organisasjoner/Flyklagenemnda
http://www.flyklagenemnda.no/
Insurance
http://forbrukerportalen.no/Organisasjoner/forsikringsskadenemnda
http://www.forsikringsklagekontoret.no/
Debt collection
http://forbrukerportalen.no/Organisasjoner/inkassoklagenemnda
http://klagenemnda.inkasso.no/
Craftsmen services for real estate
http://forbrukerortalen.no/nemnd/Klaenemnd%20for%20handverkertjenester%20pa %20fast%20eiendom
http://www.handverkerklagenemnda.no/
Car rental (not an open site, cannot be used)
http://forbrukerportalen.no/Organisasioner/klagenemnd_bilutleie
http://www.bilutleieforbund.no/http://www.bilutleieforbund.no/bransje/klagenemd/index.htm
Insurance and reinsurance
http://forbrukerportalen.no/nemnd/Klagenemnda%20for%20forsikrings-%20og%20gienforsikringsmeglingsvirksomhet
http://www.kredittilsynet.no/wbch3.exe?d=6669
Funerals
http://forbrukerportalen.no/Organisasjoner/klagenemnd_gravferd
Environment/pollution
http://forbrukerportalen.no/nemnd/1141815775.4
http://www.klagenemnd.no/
Cleaning (not an open site, cannot be used)
http://forbrukerportalen.no/Organisasjoner/klagenemnd_vask_rens
http://www.nrv.no/
Parking
http://forbrukerportalen.no/Organisasjoner/parkeringsklagenemnda
http://www.parkeringsklagenemnda.no/
Patient injuries/hospitals/medical treatment
http://forbrukerportalen.no/Organisasjoner/pasientskadenemnda
Real estate services
http://forbrukerportalen.no/Organisasjoner/klagenemnd_eiendomsmegler
http://www.eiendomsmeglingsnemnda.no/
Photography (not an open site, cannot be used)
http://forbrukerportalen.no/Organisasjoner/klagenemnd_fotograf
http://www.fotografiens-hus.no/Reklamasjoner.lasso
Package tours/tourist travel
http://forbrukerportalen.no/Organisasjoner/klagenemnd_selskapsreiser
http://www.pakkereisenemnda.no/
Valuation of real estate etc.
http://forbrukerortalen.no/Organisasjoner/klaenemnd_takst

The following are identified elsewhere:
Medical treatment abroad
http://www.klagenemnda.no/klagenemnda/(“Klagenemda for behandling i utlandet”. Not relevant at the moment)
Pre-implantation diagnostics
http://www.klagenemnda.no/pgd-nemnda/(“Preimplantasjondiagnostikksnemda”. Not relevant at the moment)
Public acquisitions
www.kofa.no (“Klagenemda for offentlige anskaffelser”. Not relevant at the moment)
Consumers' disputes
http://www.forbrukertvistutvalget.no/default.pl?showPage=176 (in particular the “Håndverkertjenester” is relevant”)
Links to Scandinavian complaints organizations
http://www.forbrukertvistutvalget.no/

Similar directories exist in most industrialized countries and can be used for the present invention.

1. A method for ranking companies providing goods and services in a marketplace,
wherein the method comprises steps for
identifying and locating sources containing information about the companies,
assigning one or more unique parameters to each source such that a parameter represents a specific type of information in a source,
selecting a set of numerical values wherein each value represents a score,
calculating a score value for each parameter as applied to a company on basis of the specific type of information input from a source and pertaining to that company,
weighting each calculated score value, and
computing a rank value for each company on basis of an aggregation of all weighted score values for said each company.

2. A method according to claim 1, characterized by
determining the sources as documents, sites, or information providers on the World Wide Web.

3. A method according to claim 1, characterized by
selecting the same set of numerical values for all parameters when calculating the score values thereof.

4. A method according to claim 1, characterized by
selecting the set of numerical values as a monotonically increasing series of integers, preferably as the series [1, 2, n], where n is a maximum score.

5. A method according to claim 1, characterized by
defining a score value of a parameter as a quality attribute of the parameter.

6. A method according to claim 1, characterized by weighting a score value with a weight selected as a real number in the interval <0, 1].

7. A method according to claim 1, characterized by
computing one or more additional rank values for a company on basis of respective one or more subsets of the weighted score values.

8. A method according to claim 1, characterized by
searching the World Wide Web and retrieving all links to a company,
assigning to each retrieved link one or more of the parameters assigned to the sources and determined to be relevant to the link, and
Appending the weighted score value of said one or more parameters to the link as a rank value thereof, whereby the links to that company can trivially be ranked.

9. A method according to claim 8, characterized by
assigning said one or more parameters on basis of a comparison of the information types represented by the parameters and a information type or types as covered by the link.

10. A method according to claim 8, characterized by
crawling the World Wide Web for searching and retrieving the links

11. Use of method according to claims 1-7 in an online searchable database of companies providing goods and services in a marketplace, including displaying the result of a search as a list of companies in order of a computed rank value for each company, wherein the rank value is an overall measure of the quality and business performance of that company.

12. A method for use of the method according to claim 8 in an online searchable database of companies providing goods and services in a marketplace, for displaying the result of search as a list of companies with links to each company retrieved from the World Wide Web and ranked in order of an assigned score value of each link, wherein the score value of a link to a specific company is a measure of a relevance of the link for assessing the quality and business performance of that company.
